(19) United States
(12) Patent Application Publication
(10) Pub. No.: US 2015/0185829 A1
(43) Pub. Date: Jul. 2, 2015

(54) Method and apparatus for providing hand gesture-based interaction with augmented reality applications

(71) Applicant: Datangle, Inc., San Jose, CA (US)

(72) Inventors: Rick C. Yang, San Jose, CA (US); Taizo Yasutake, Cupertino, CA (US)

(21) Appl. No.: 14/583,661

(22) Filed: Dec. 27, 2014

Related U.S. Application Data
(60) Provisional application No. 61/964,190, filed on Dec. 27, 2013.

(51) Int. Cl. G06F 3/01; G06T 19/00

(52) U.S. Cl. CPC G06F 3/011; G06F 3/017; G06T 19/006; G06T 2215/16

(57) ABSTRACT

Techniques of allowing users of computer devices to interact with any augmented reality (AR) based multi-media information using simple and intuitive hand gestures are disclosed. According to one aspect of the present invention, an image capturing device (e.g., a video or photo camera) is used to generate images from which a pre-defined hand gesture is identified in a target image for displaying AR information. In addition, a hand trajectory may be detected from a sequence of images while the hand is moving with respect to the target. Depending on implementation, the target may be a marker or a markerless image.

### CROSS-REFERENCE TO RELATED APPLICATION

This application claims the benefits of U.S. Provisional Application No. 61/964,190, filed Dec. 27, 2013, and entitled “Method and Apparatus to Provide Hand Gesture Based Interaction with Augmented Reality Application”, which is hereby incorporated by reference for all purposes.

### BACKGROUND OF THE INVENTION

1. Field of the Invention

The invention is generally related to the area of augmented reality (AR). In particular, the invention is related to techniques for detecting optically a blocked area in a target image, where an AR target being blocked or how it is being blocked by an object is evaluated in a real time to generate different input commands for user interactions.

2. The Background of Related Art

Augmented Reality (AR) is a type of virtual reality that aims to duplicate the world's environment in a computer device. An augmented reality system generates a composite view for a user that is the combination of a real scene viewed by the user and a virtual scene generated by the computer device that augments the scene with additional information. The virtual scene generated by the computer device is designed to enhance the user's sensory perception of the virtual world the user is seeing or interacting with. The goal of Augmented Reality (AR) is to create a system in which the user cannot tell the difference between the real world and the virtual augmentation of it. Today Augmented Reality is used in entertainment, military training, engineering design, robotics, manufacturing and other industries.

The recent development of computer devices such as smart phones or tablet PC and cloud computing services allow software developers to create many augmented reality application programs by overlaying virtual objects and/or additional 2D/3D multi-media information within a captured image by a video camera. When an interactive user interface is required in an AR application, a typical interface design is to generate input commands by finger gestures on a surface of a touch screen of the computer device. However, the interaction on a large touch screen would be very inconvenient for users to interact with an AR display. In order to overcome this sort of ergonomic difficulties, some AR applications introduced sophisticated algorithms to recognize hand/finger gestures in free space. The image sensing device, such as Kinect from Microsoft or Intel 3-D depth sensor, is gaining popularity as a new input method for real-time 3-D interaction with AR applications. However, these interaction methods require highly sophisticated image processing mechanisms involving a specific device along with various software drivers, where an example of the specific device includes a 3-D depth sensor or a RGB video camera. Thus there is a need for techniques of generating input commands based on simple motions of an object or intuitive gestures of the object, where the object may be a hand and something to be held by a user.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention.

In general, the present invention is related to techniques of allowing users of computer devices to interact with any augmented reality (AR) based multi-media information using simple and intuitive hand gestures. According to one aspect of the present invention, an image capturing device (e.g., a video or photo camera) is used to generate images from which a pre-defined hand gesture is identified on a target image for displaying AR information. One of the advantages, objects and benefits of the present invention is to allow a user to interact with a single target to display significant amounts of AR information. Depending on implementation, the target may be a marker or a markerless image. The image of the target is referred to herein as a target image.

According to another aspect of the present invention, a photo or video camera is employed to take images of a target. With a hand to move with respect to the target and block some or all of the target, a hand motion is detected based on how much the target is being blocked in the images.

According to still another aspect of the present invention, each motion corresponds to an input command. There are a plurality of simple motions that may be made with respect to the target. Thus different input commands may be provided by simply moving a hand with respect to the target.

According to yet another aspect of the present invention, an audio feedback function is provided with a confirmation of an expected command by hand gesture. For example, a simple swipe gesture of hand from left to right across a target could provide the sound of piano when the moving speed of hand gesture is slow, resulting in blocking the target for a relatively long period. When the same swipe gesture is fast, resulting in blocking the target for a relatively short period, then the audio feedback can be set to a whistle sound.

The present invention may be implemented as an apparatus, a method or a part of a system. Different implementations may yield different merits in the present invention. According to one embodiment, the present invention is a system for providing augmented reality (AR) content, the system comprises: a physical target, a computing device loaded with a module related to augmented reality, a video camera, aiming at the physical target, coupled to the computing device, wherein the module is executed in the computing device to cause the computing device to display a first object when the physical target in a target image is fully detected and to cause the computing device to display a second object or conceal the first object when the physical target in the target image is partially detected or missing.

According to another embodiment, the present invention is portable device for providing augmented reality (AR) content, the portable device comprising: a camera aiming at a physical target; a display screen, a memory space for a module; a processor, coupled to the memory, executing the module to cause the camera to generate a sequence of target images while a user of the portable device moves a hand with respect to the physical target, wherein the module configured to cause the processor to determine from the target images whether or how the physical target is being blocked by the hand, the processor is further caused to display an object on the display screen when the physical target is detected in the images, and determine a motion of the hand when the physical target is partially detected in the images, where the motion corresponding to an input command.

According to yet another embodiment, the present invention is method for providing augmented reality (AR) content, the method comprising: providing a module to be loaded in a computing device for execution, the module requiring a video camera to aim at a physical target, the video camera coupled to a computing device, wherein the computing device is caused to display a first object when the physical target in a target image is fully detected, and to display a second object or conceal the first object when the physical target in the target image is partially detected.

One of the objects, features and advantages of the present invention is to provide a mechanism of interacting with an AR module. Other objects, features, benefits and advantages, together with the foregoing, are attained in the exercise of the invention in the following description and resulting in the embodiment illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1A shows an exemplary setup to practice one embodiment of the present invention;

FIG. 1B shows a functional block diagram of a computing device that may be used in FIG. 1A to practice one embodiment of the present invention;

FIG. 1C shows an exemplary fiducial marker for augmented reality;

FIG. 1D shows a marker based augmented reality application and a corresponding 3D object display in a displayed image;

FIG. 1E shows an exemplary markerless target for augmented reality;

FIG. 1F shows an augmented reality with a markerless target and a corresponding 3D object in a displayed image;

FIG. 2A and FIG. 2B illustrate a marker without any obstacles and the same marker being blocked by a hand;

FIG. 2C illustrates a basic flowchart of image processing and display of AR object by a conventional AR module;

FIG. 2D illustrates a flowchart or process of marker-based AR application including the recognition of hand gesture and a corresponding command to display one or more AR objects;

FIG. 3A illustrates that a marker has no obstacles;

FIG. 3B illustrates that a left portion of the marker is blocked by a hand;

FIG. 3C illustrates that a major portion of the marker is blocked by a hand;

FIG. 3D illustrates that a right portion of the marker is blocked by a hand;

FIG. 3E illustrates recovery of the marker after it has been blocked by a hand;

FIG. 3F shows a flowchart or process of image processing and receiving an input command using hand movement and its moving direction;

FIG. 3G illustrates the computation of a center position of optically blocked area;

FIG. 3H illustrates a moving direction of the center of optically blocked area by hand gesture;

FIG. 3I illustrates the computation of unwarped image by a perspective transformation and its local 2D coordinates;

FIG. 4A illustrates that a left portion of a markerless target is being blocked by a hand;

FIG. 4B illustrates that a major portion of a markerless target image is being blocked by a hand

FIG. 4C illustrates that a right portion of a markerless target image is being blocked by a hand;

FIG. 4D illustrates a basic flow chart of markerless AR application including the recognition of hand gesture and its command to display AR objects;

FIG. 4E shows a flowchart or process of image processing and receiving an input command using hand movement and its moving direction;

FIG. 4F illustrates the estimation of a moving direction of a hand using the captured images and identified key points in a markerless AR target image;

FIG. 5A illustrates hand gestures by horizontal or vertical swipe;

FIG. 5B illustrates hand gestures by U-turn movement at each side of target image;

FIG. 5C illustrates hand gestures by U-turn movement at each vertex of target image;

FIG. 6 illustrates audio feedback when a hand gesture is correctly recognized;

FIG. 7 illustrates an enclosure containing multiple targets

FIG. 8A illustrates a round piece of paper or a cylindrical object with graphics thereon as a markerless target;

FIG. 8B illustrates a hand gesture and a display of AR object using the markerless target of FIG. 8A;

FIG. 9A illustrates a supplemental mirror setting to provide a reflective camera angle for an AR user of desktop PC; and

FIG. 9B illustrates a mirror and its mount on a PC screen to obtain the reflective camera angle.

### DESCRIPTION OF THE PREFERRED EMBODIMENTS

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

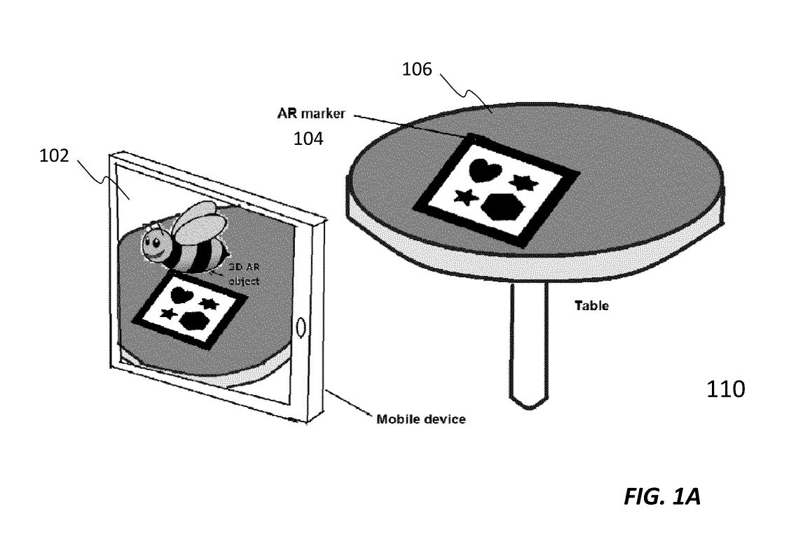

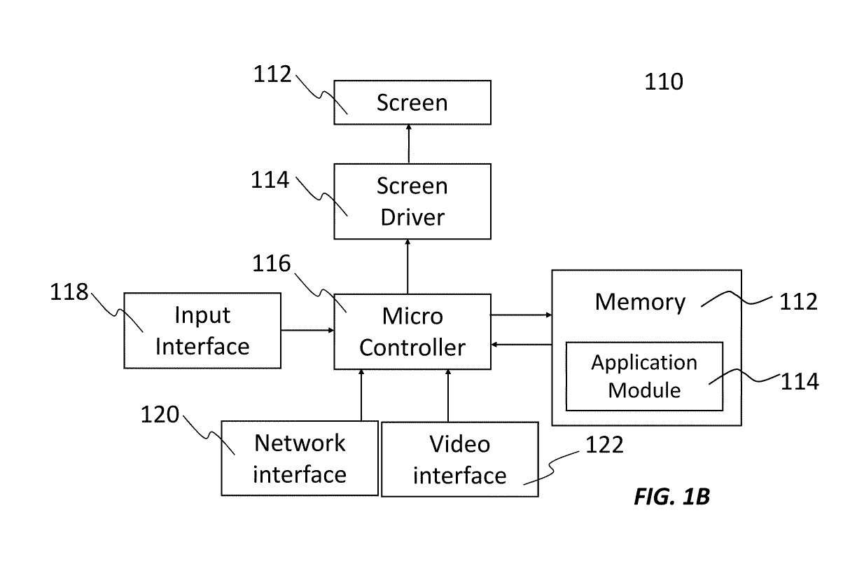

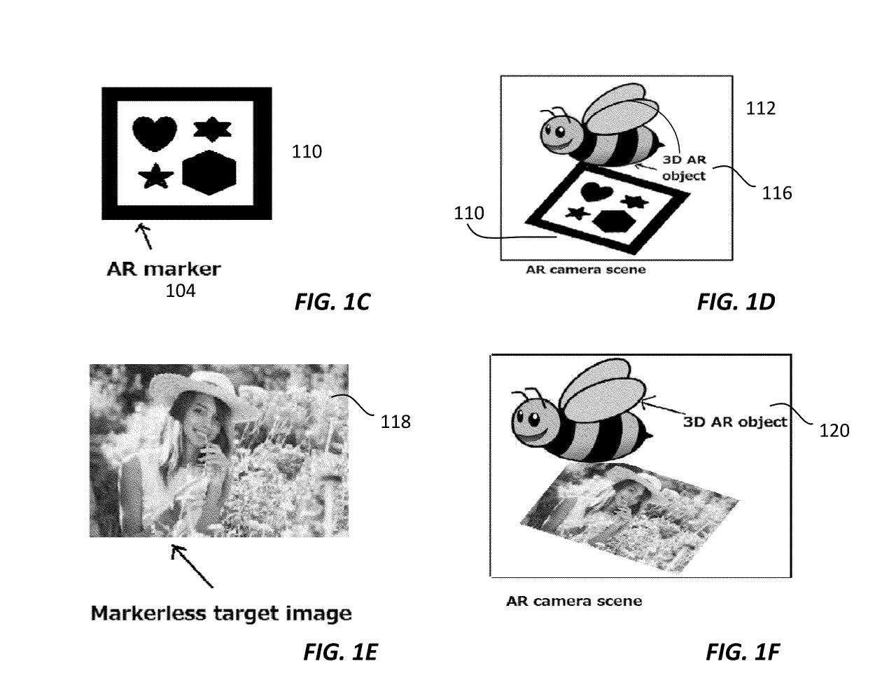

Embodiments of the present invention are discussed herein with reference to FIGS. 1A-9B. However, those skilled in the art will readily appreciate that the detailed description given herein with respect to these figures is for explanatory purposes as the invention extends beyond these limited embodiments.

FIG. 1A shows one exemplary setup 100 that may be used to practice one embodiment of the present invention. The setup 100 includes a computing device with a video camera (not visible) provided to take images of an AR maker 104 that may be a printout or made out of a material and is disposed on a surface 106 (e.g., a table). An example of the computing device 106 may be, not limited to, a desk computer with or coupled to a webcam, a smartphone and a tablet.

FIG. 1B illustrates an internal functional block diagram 110 of a computing device that may correspond to the computing device 106 of FIG. 1A. The screen 112 may be a touch screen (e.g., LCD or OLED) or a representation of a projection (e.g., providing projection signals). The screen 112 communicates with and is commanded by a screen driver 114 that is controlled by a microcontroller (e.g., a processor) 116. The memory 112 may be loaded with one or more application modules 114 that can be executed by the microcontroller 116 with or without a user input via the user interface 118 to achieve desired tasks. The computing device further includes a network interface 120 and a video interface 122. The network interface 120 is provided to enable the computing device 110 to communicate with other devices through a data network (e.g., the Internet or LAN). The video interface 122 is coupled to a video capturing device (e.g., a CMOS camera, not shown).

In one embodiment, an application module 114, referred to herein as an AR application or module, is designed to perform a set of functions that are to be described further herein. The application module 114 implements one embodiment of the present invention and may be implemented in software. A general computer would not perform the functions or results desired in the present invention unless it is installed with the application module and execute it in a way specified herein. In other words, a new machine is created using a general computer as a base component thereof. As used herein, whenever such a module or an application is described, a phase such as the module is configured to, designed to, intended to, adapted to do a function means that the newly created machine has to perform the function unconditionally.

In particular, when the AR module 114 is executed, the computing device 110 receives the images or video from the video interface 122 and processes the images or video to determine if there is a target image or not, and further to overlay one or more AR objects on a real scene image or video when such a target image is detected. It should be noted that a general computer is not able to perform such functions unless the specially designed AR module 114 is loaded or installed and executed, thus creating a new machine.

According to one embodiment, the AR marker 104 may be in a certain pattern and in dark color. FIG. 1C shows one example of an AR marker 104. The image 110 of the marker 104 is referred to as a target image. It may be superimposed, overlaid or blended into a natural scene image 112 of FIG. 1D. As will be further described below, when the image 110 is detected and confirmed, a corresponding AR object 116 is shown in the image 112, thus an Augmented Reality (AR).

Depending on implementation, the image 112 may be displayed on a computing device taking pictures or video of a natural scene or any designated display device. As shown in FIG. 1A, an example of the computing device may be a smart phone (e.g., iPhone) or a tablet computer.

Referring now to FIG. 1E, it shows an example of an image 118 that is also referred to herein as a markerless target image. The image 118 may be taken by a photo camera and used as a target image in an AR application. FIG. 1F shows a corresponding AR image 120 that includes a 3D AR object 116.

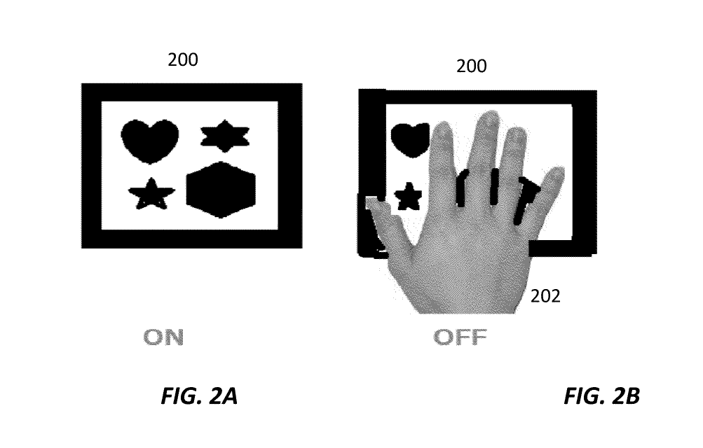

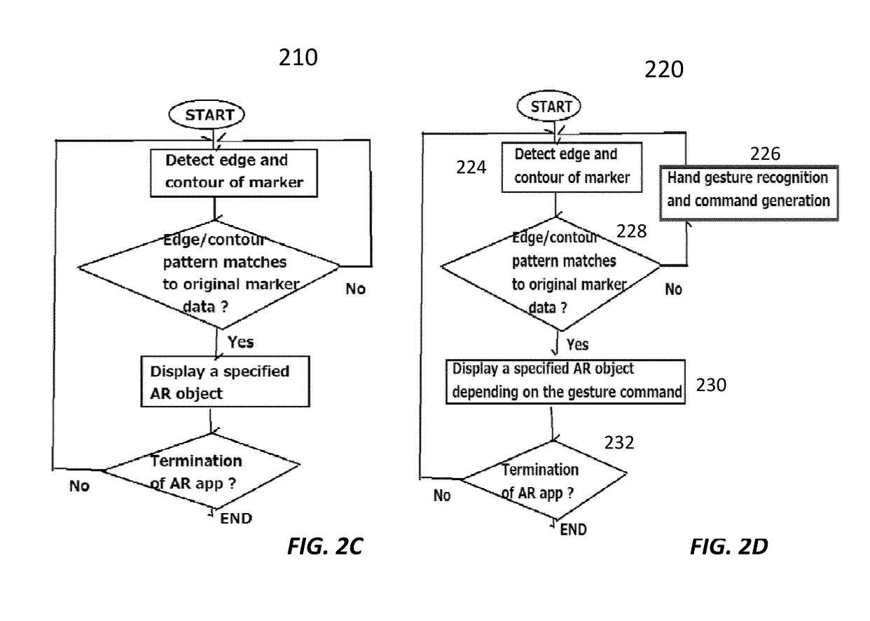

FIG. 2A and FIG. 2B depict a basic hand gesture to generate an input command for interaction with an AR application. FIG. 2A shows that a marker 200 is being laid open and imaged by a camera (not shown). FIG. 2B shows that a user covers a significant portion of the marker 200 with his/her hand. This action optically interrupts the detection of the marker by the camera, resulting in an image with the marker 200 being significantly covered by a hand. The AR module being executed in a computing device is designed to make a decision about the current status of the image whether the marker has been successfully captured (thus the status is ON) or the marker has not been successfully captured (thus failed and the status is OFF). If the failed status exceeds a pre-defined time period and the success status is coming back after the failed status is gone, then the AR module is designed to interpret this one bit status change (ON-OFF) as an intention from the user for an input command.

According to one embodiment, the AR module is configured to display a first AR object after it successfully captures the marker 200 in FIG. 2A. The user then blocks off the marker 200 with his/her hand for a while (e.g., 500 milliseconds) as shown in FIG. 2B. The user then removes his/her hand from the marker 200. Upon receiving the correct image of marker 200, the AR module displays a second AR object. In this case, the hand gesture or the blocking and unblocking action is utilized as a toggle switch command to display the current AR object #1 to another one, AR object #2. If the hand gesture is identified again, then a next one, AR object #3, could be displayed. This means that a single AR target image could display a certain amount of AR information using above hand gesture as if the user browses an e-book.

Referring now to FIG. 2C, it shows a flowchart 210 of a typical AR application program using an AR marker. The AR application executes an image processing algorithm to detect edges and contours of the marker after capturing the marker by a video camera. The edge and contour detection algorithm usually adopts a binarization process of the marker image with a threshold value and edge filtering method to correctly identify the edges and contours of the marker. These extracted data is compared with the original geometric data of the marker before displaying an AR object.

FIG. 2D shows a process or a flowchart 220 according to one embodiment of the present invention. In one perspective, the flowchart 220 is a modification of the flowchart 210 of FIG. 2C. In particular, a hand recognition mechanism and the generation of pre-defined input commands are added in the flowchart 220. The process 220 may be implemented in software or a combination of software and hardware.

According to one embodiment, a marker image is identified from a captured image provided from an image capturing device (e.g., a camera). The marker image is then processed to detect the edge and contour of the marker. Algorithms that may be used in processing a marker image are well known to those skilled in the art and will not be further described herein to avoid obscuring aspects of the present invention.

Once the edge and contour of the marker are extracted from an image, the parameters representing the edge and contour of the marker are to be matched with or compared to the same of the original marker image (i.e., as a marker descriptor, reference or template). When the process 220 is determined that there is no match between the detected marker and the marker template, the process 220 goes to 226 where the hand gesture is to be detected. For example, when a hand blocks a significant portion of the marker as shown in FIG. 2B for a period, a marker will not be detected in the image. As a result, the process 220 goes to 226.

As will be described below, the hand motion is detected at 226 to determine how the hand is moving. The motion of the hand, when detected from a sequence of images, can be interpreted as a command. More details of detecting the motion will be further described herein.

When the process 220 is determined that there is a match between the detected marker and the marker template, the process 220 goes to 230 to display a predefined AR object. For example, when the marker as shown in FIG. 2B is not being blocked by the hand, a marker will be detected in the image. As a result, the process 220 goes to 230. Upon displaying the corresponding AR object, the process 220 goes to 232 to determine if the AR module ends or an additional action from a user is needed. For example, a user puts his/her hand out to block some of the marker, resulting in an image of blocked target image. The AR module is designed to respond to such a target image to either remove the displayed AR object or display another AR object.

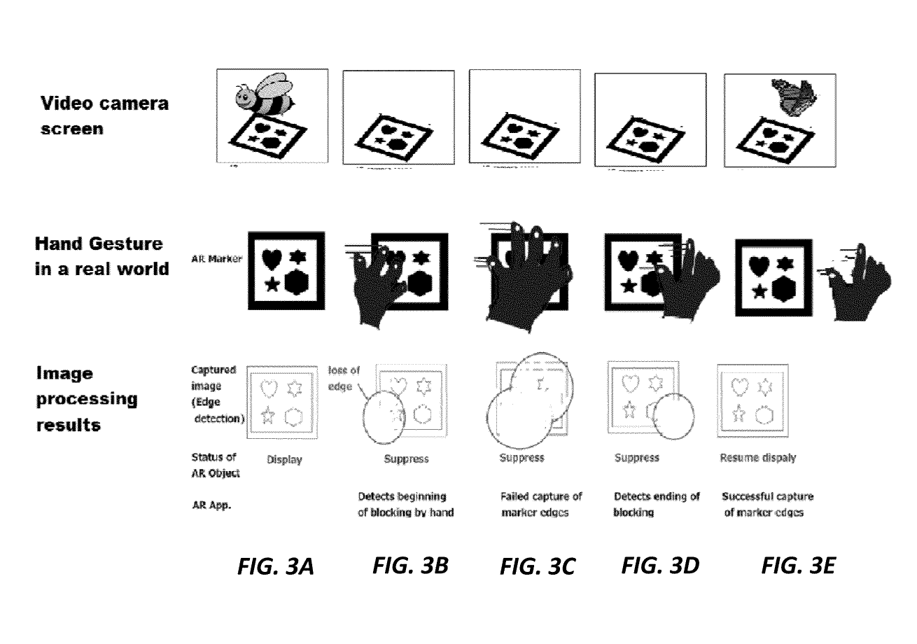

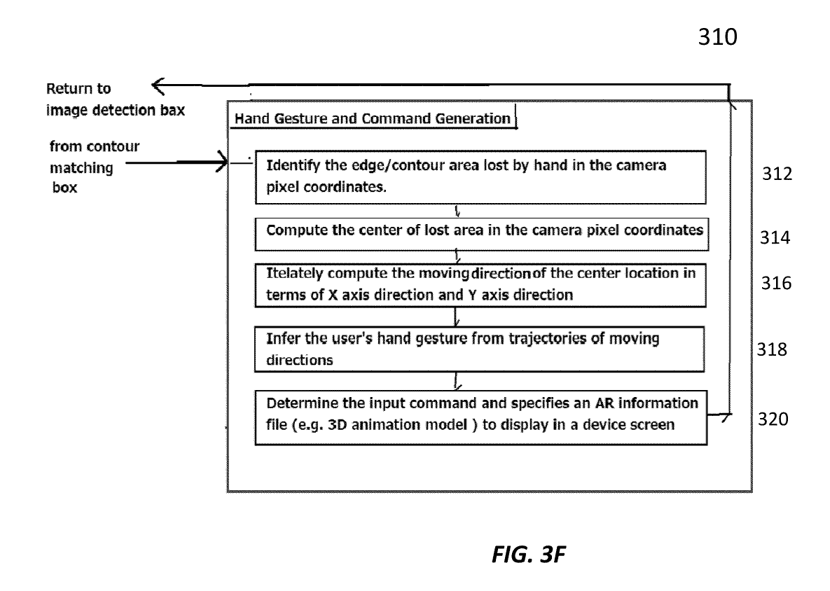

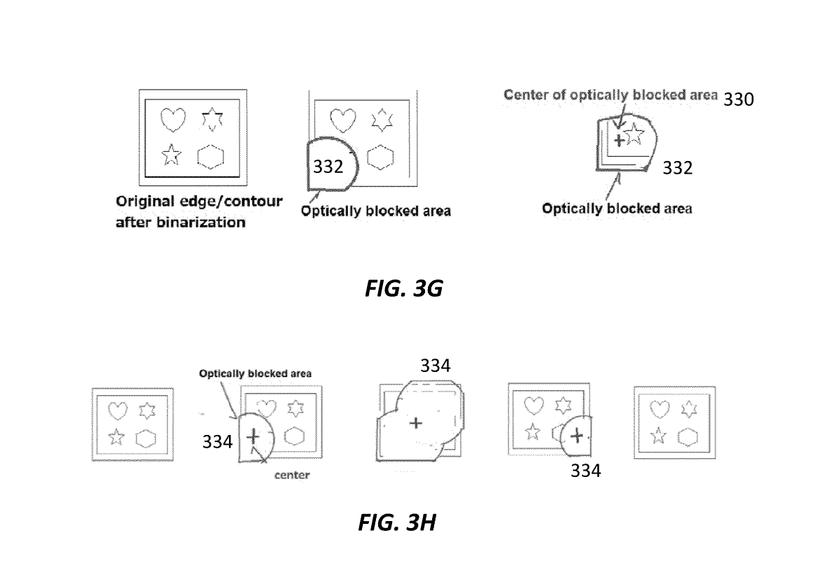

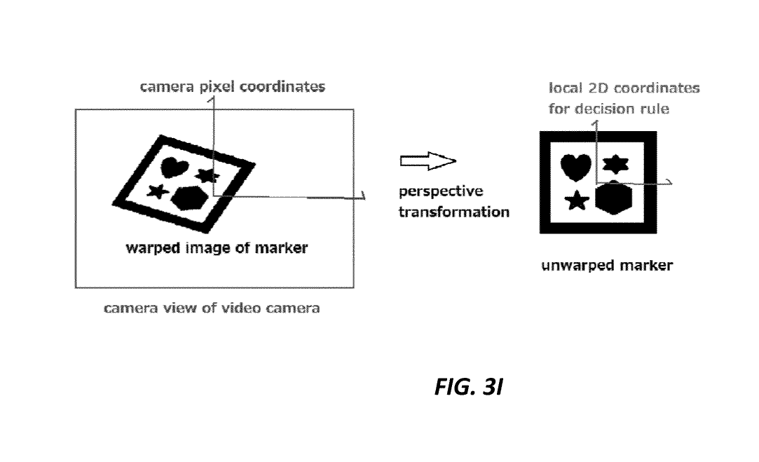

FIG. 3A to FIG. 3E depict a sequential stage of interactions by hand movements and corresponding processed target images. In FIG. 3A, the AR module correctly detects edges and contours of the marker in a captured image and thus displays an AR object. In FIG. 3B, a user hand is partially blocking a left side of the marker. This causes a failure of the marker identification and resulting in suppression of the AR object display. In FIG. 3C, the hand almost entirely covers the marker, causing the AR object continues not to be shown. In FIG. 3D, the hand is partially blocking a right side of the marker. In FIG. 3E, the marker image is successfully captured and detected in the captured image. As a result, the display of a new AR object is resumed. Alternatively, the AR object of FIG. 3A can be disappeared or concealed when the swipe of the hand across the marker is finished.

According to one embodiment, the above sequence of image events, the AR module or a separate module is designed to record or estimate the timing in the display stage and the suppress stage of the AR object depending on the degree of how much the marker has been blocked by the hand. Based on the progress of blocking the marker, from little to significant and then to little, the module is designed to detect or estimate the motion direction of the hand using the sequence of locations the marker being blocked.

Referring now to FIG. 3F, it depicts a detailed computational flowchart or process 310 of hand gesture recognition and command generation, according to one embodiment of the present invention. Depending on implementation, the process 310 may be implemented in software or in combination of software and hardware.

According to one embodiment, the process 310 starts when there is a mismatch between a detected marker and a marker template, or a missing status of a marker in a captured image. The process 310 may be used at 226 of FIG. 2D. In FIG. 3F, the process 310 is already acknowledged that there is a mismatch between the detected pattern of the marker and the template. Therefore, the process 310 is designed to identify the region of the lost edges or contours of the marker at 312. In a sense, the process 310 is designed to compute the edges or contours of the blocked area in the captured image. The process 310 is then to compute its center location of the optically blocked area in terms of pixel coordinates at 314. Based on the gradually increased or decreased blocked areas in the sequence images, the moving direction or trajectory of the hand can be determined or estimated at 316.

Once the moving direction is determined or estimated, the hand gesture is inferred at 318. Depending on implementation, a set of predefined commands may be determined per the hand motions. For example, a first kind of AR object is displayed when a hand is moving from left to right, a second kind of AR object is displayed when a hand is moving downwards. At 320, the AR module is designed to receive a corresponding input and reacts to the input (e.g., display a corresponding 3D AR object among a set of predefined objects).

The calculation for tracking a center of the lost edge/contour area continues until the camera resumes the successful image capturing of the marker. Using the tracking data of the center of lost edge/contour area, the process 310 could identify the moving direction of the hand (e.g.; the hand is moving from left to right, or forward to backward, and so on).

According to one embodiment, FIG. 3G shows how to compute the center 330 of an optically blocked area 332 in the pixel coordinates (Cxav, Cyav). A data manipulating technique or a computation method is designed to identify the optically blocked area 332 by calculating averaged positions of the minimum pixel value of X coordinates and the maximum pixel value of X coordinates within the optically blocked area as Cxay. Cyav is also obtained by calculating averaged positions of the minimum pixel value of Y coordinates and the maximum pixel value of Y coordinates within the optically blocked area.

FIG. 3I shows a sequence of images in which the block area 334 is gradually increased and then decreased, where the corresponding calculated center coordinates are moving accordingly. When the marker image is captured not from the top view, but from a side angle, the captured target image is warped and cannot simply be compared with the marker template to identify the optically blocked area. In order to correctly compare the captured target image and a reference image (or the template), in one embodiment, a transformation module is designed to execute a perspective transform of the captured image from a current camera perspective view to an unwarped target image as shown in FIG. 3I. Then, this unwarped image is used for processing to compare the detected marker with the reference image.

FIG. 3H also shows how to determine the moving direction of a hand by using the calculated centers of the optically blocked areas in the images. In one embodiment, FIG. 3I depicts the local 2D coordinates for decision rule. This could be obtained by perspective transformation of the marker which is captured in the camera view defined by the camera pixel coordinate. The local 2D coordinates is defined at the center of the marker shown in FIG. 3I.

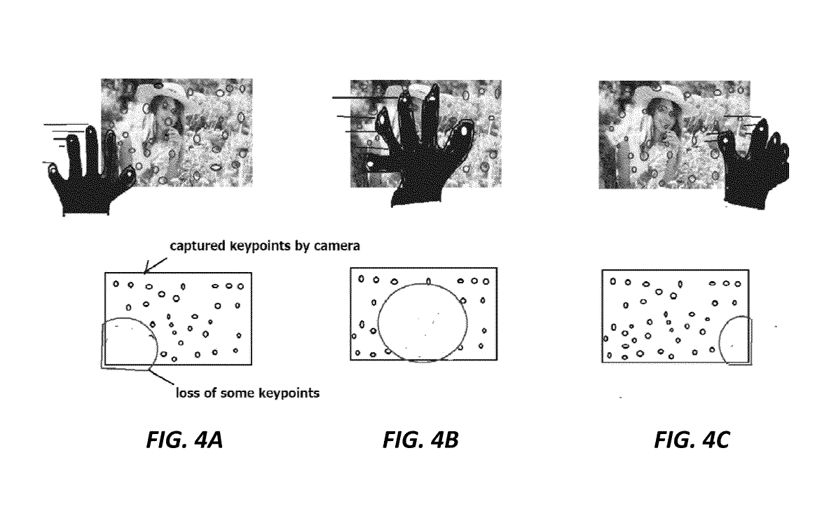

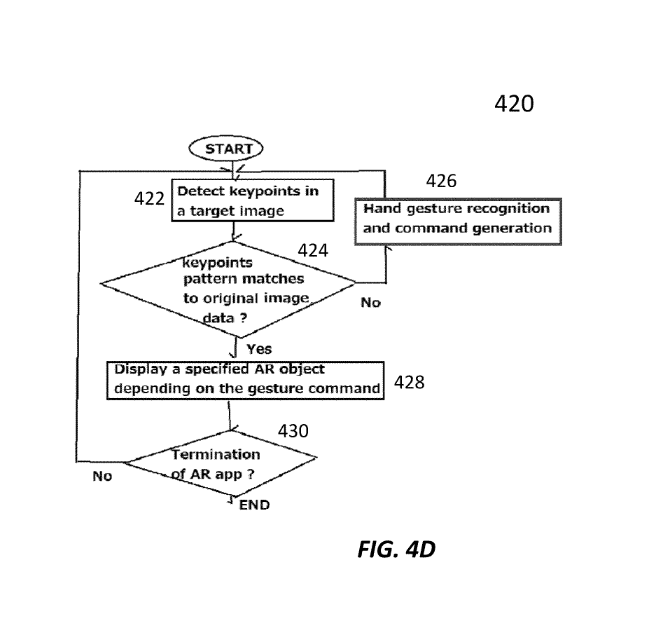

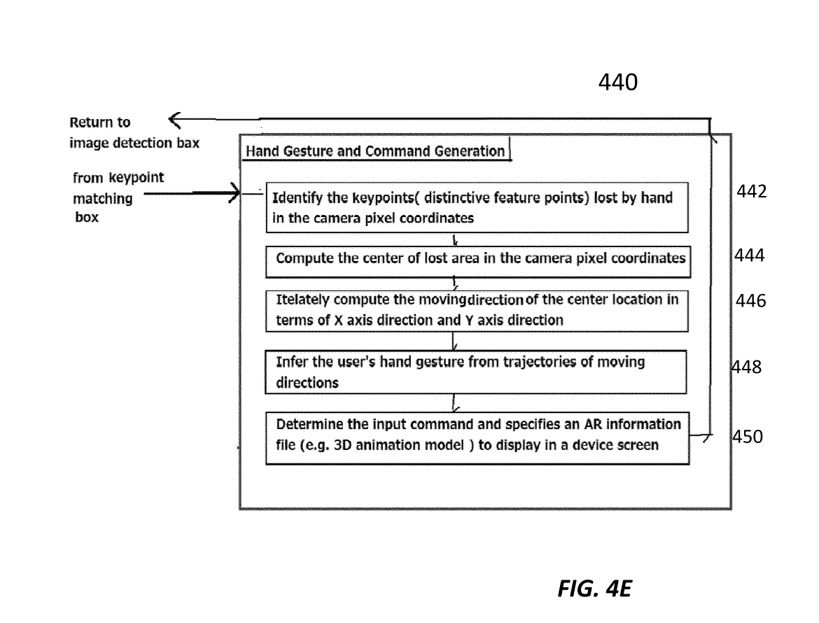

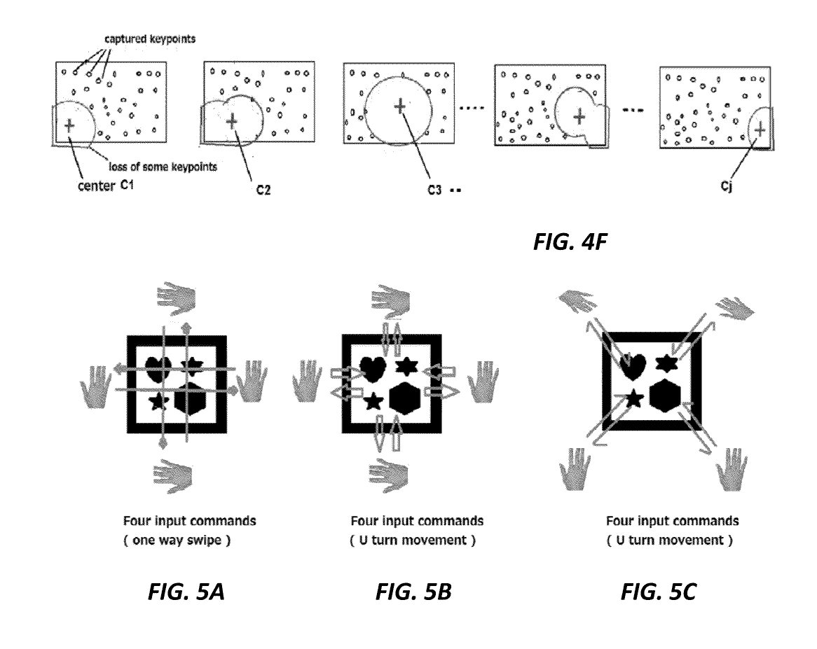

According to one embodiment, FIG. 4A to FIG. 4C show respective interactions with an AR module using a markerless target image. Some of the key points, or distinctive feature points, such as strong color changes or sharp corners, are artificially highlighted in circles to facilitate the understanding of the embodiment. These highlighted key points, also referred to as feature points herein, are identified in pixel coordinates. The detected distinctive feature points are shown separately in black circles without the details of the images, where the feature points are presented in pixel coordinates.

According to one embodiment, when the target is blocked by a hand, corresponding missing distinctive feature points in captured images are noted or tracked when a hand is moving over the target image. By tracking how many feature points are remaining or missing from one image to another, the motion of the hand can be detected. In other words, given the number of the feature points in a target image, by detecting the remaining feature points in a sequence of images (some of the feature points would not be detected due to the blocking by the hand), the motion of the hand can be fairly well detected. In one embodiment, some examples of the distinctive feature points may be a tiny pixel region in a reference image (i.e., a template of the feature points) that has graphical properties of sharp edge/corner or strong contrast, similar to a bright spot on a dark background.

FIG. 4D shows a computational flowchart or process 420 of an AR module designed or configured to support user interactions with a markerless image. The process 420 may be implemented in software or in combination of software and hardware. To put the process 420 into a practical AR application, a template of a markerless image is first generated, where the template shall be used in subsequent detections of the markerless target in captured images from a video camera. As indicated above, a markerless image may be almost anything other than a predefined marker. Preferably, a markerless image shall have some distinctive features therein, for example, sharp color changes, corners, edges, or patterns. As an example herein, a magazine page showing significant features as mentioned above is used. When taken by a photo camera or a video camera, an image of the page is referred to as a markerless image.

In general, the image is in colors, represented in three primary colors (e.g., red, green and blue). To reduce the image processing complexity, the color image is first converted into a corresponding grey image (represented in intensity or brightness). Through an image algorithm, distinctive feature points in the image are extracted. To avoid obscuring the aspects of the present invention, the description of the image algorithm and the way to covert from a color image to a grey image are ignored herein. Once the distinctive feature points are extracted from the image, a template of the markerless image can be generated. Depending on implementation, the template may include a reference image with the locations of the extracted feature points or a table of descriptions of the extracted feature points.

Referring now back to 422, after a natural image including the magazine page is taken, the captured image is processed at 422 to detect the feature points in the region containing the magazine page. If needed, the captured image may be warped before being processed to detect the feature points in the region containing the magazine. At 424, the detected feature points are then compared with the template. If there is no matching or an indication that some of the feature points are missing, the process 420 goes to 426, where the hand gesture is recognized and a corresponding command is interpreted by tracking the positions of the remaining feature points in the captured images. In one embodiment, the image may be warp-transformed to be processed again if there is no match between the detected feature points and the template at 424 or a comparison ratio is near a threshold. The detail of tracking the remaining feature points in the captured images will be further described in FIG. 4E.

It is now assumed that there is a match between the detected feature points and the template at 424, which means the markerless image is detected in the image, the process 420 then goes to 428 to call the AR module to display a predefined AR object. It should be noted that the match does not have to be perfect, a match is called if the comparison or the similarity exceeds a certain percentile (e.g., 70%). While the AR object is being displayed, the process 420 goes to 430 to determine if another image is received or an action from a user is received.

Referring now to FIG. 4E, it depicts a detailed computational flowchart or process 440 of hand gesture recognition and command generation that may be used in the process 420 of FIG. 4D, according to one embodiment of the present invention. Depending on implementation, the process 420 may be implemented in software or in combination of software and hardware.

According to one embodiment, the process 420 starts when there is a mismatch between a detected marker and a marker template or missing of certain feature points in a captured image. When the process 440 is used at 426 of FIG. 4D, the process 440 is already acknowledged that there is a mismatch between the detected feature points of the markerless image and the template. Therefore, the process 440 is designed to locate and identify the feature points at 442. In a sense, the process 440 is designed to compute or locate the feature points in terms of pixel coordinates. In one embodiment, the process 440 is to compute a center location of a region that has a feature point in terms of pixel coordinates at 440. Based on the gradually increased or decreased blocked areas in the sequence images, the moving direction or trajectory of the hand is determined or estimated at 446.

Once the moving direction is determined or estimated, the hand gesture is inferred at 448. Depending on implementation, a set of predefined commands may be determined per the hand motions. For example, a first kind of AR object is displayed when a hand is moving from left to right, a second kind of AR object is displayed when a hand is moving downwards. At 450, the AR module is designed to receive a corresponding input and reacts to the input (e.g., display a corresponding 3D AR object among a set of predefined objects). The calculation for tracking the center of lost edge/contour area continues until the camera resumes the successful image capturing of the target image. Using the tracking data of the center of lost edge/contour area, the process 440 could identify the moving direction of hand (e.g.; the hand is moving from left to right, or forward to backward, and so on).

FIG. 4F shows how to estimate the moving direction of a hand using the captured images and those distribution of key points in a markerless AR target image. The estimation procedures for the center of region that contains unidentified key points are shown as follows:

A point C(Xav, Yav) is defined as a center of key points that are lost from currently captured image. For example, there are j key points, K1(x1,y1), K2(x2,y2), . . . , Kj(xj,yj) are lost from a captured image at time t1;

Average x location of C1(Xav)=(x1+x2+ . . . +xj)/j at time t1; and

Average y location C1(Yav)=(y1+y2+ . . . +yj)/j at time t1.

Using the above equation, the center for the lost key points C2(xav,Yav) at time t2 could be computed in the same way using lost key point set at time t2. Next, the center locations can be iteratively computed until time tk, C1(Xav,Yav) at time t1, C2(Xav,Yav) at time=t2, . . . , Ck(Xav,Yav) at time=tk. It should be noted that C1 should be observed at beginning of the hand blocking the target (at time t1) and Ck should be observed at ending of of the hand blocking the target (at time tk).

FIG. 5A to FIG. 5C show a dozen of different input commands using pre-defined hand gestures. Particularly FIG. 5A shows four different swipe gestures along horizontal directions and vertical directions. FIG. 5B shows “U-turn” gestures adjacent to each of the boundaries of the markerless image. FIG. 5C shows another “U-turn” gesture set adjacent to each diagonal directions of the markerless image. According to one embodiment, decision rules are designed for FIG. 5A, FIG. 5B and FIG. 5C as follows:
(i) Identifying a dominant movement of Cxav or Cyav
(ii) Identifying a moving direction of center Cxav and Cyav with Checking: direction of beginning and direction of ending (horiz/vert swipe, horiz/vert U-turn or diagonal U-turn)
   For decision rules of moving dominance and generic moving direction:

if a sum of absolute changes of X coordinates C1 . . . Ck is greater than a sum of absolute change of Y coordinates of C1 . . . Ck and its difference is greater than a user specified threshold value, then the movement of Cxav dominates and movement direction is occurred in the X axis.

If a sum of absolute changes of Y coordinates of C1 . . . Ck is greater than a sum of absolute change of X coordinates of C1 . . . Ck) and its difference is greater than user specified threshold value, then the movement of Cyav dominates and movement direction is occurred in the Y axis.

If a sum of absolute changes of X coordinates of C1 . . . Ck is greater than the user specified threshold value_x and a sum of absolute change of Y coordinates of C1 . . . Ck) is also greater than the user specified threshold value_y, then the movement direction of C is diagonal in X-Y coordinates.

Specifically, for FIG. 5A,
If the movement of Cxav dominates, the movement direction is occurred in the X axis, and the X axis element of Ck is greater than the X axis element of C1, then the direction of hand movement is from left side to right side;
If the movement of Cxav dominates, the movement direction is occurred in the X axis, and the X axis element of Ck is smaller than the X axis element of C1, then the direction of hand movement is from right side to left side;
If the movement of Cyav dominates and movement direction is occurred in the Y axis, and the Y axis element of Ck is greater than the Y axis element of C1, then the direction of hand movement is from bottom side to top side; and
If the movement of Cyav dominates and movement direction is occurred in the Y axis, and the Y axis element of Ck is smaller than the Y axis element of C1, then the direction of hand movement is from top side to bottom side.

Specifically, for FIG. 5B,
If the movement of Cxav dominates and movement direction is occurred in the X axis, and the X axis element of midpoint Ci is greater than the X axis element of C1, then the direction of hand movement is from left side to right side;
if the movement of Cxav dominates and movement direction is occurred in the X axis, and the X axis element of the next sequence point Ci+1 from Ci is greater than the X axis element of Ck, then the direction of hand movement is from right side to left side. Finally, if the movement direction is changed during the decision process period, then the hand movement is U-turn from right then left on the X axis;
If the movement of Cxav dominates and movement direction is occurred in the X axis, and the X axis element of midpoint Ci is smaller than the X axis element of C1, then the direction of hand movement is from right side to left side;
If the movement of Cxav dominates and movement direction is occurred in the X axis, and the X axis element of the next sequence point Ci+1 from Ci is smaller than the X axis element of Ck, then the direction of hand movement is from left side to right side; and
finally, if the movement direction is changed during the decision process period, then the hand movement is U-turn from left then right on the X axis;
If the movement of Cyav dominates and movement direction is occurred in the Y axis, and the Y axis element of midpoint Ci is greater than Y axis element of C1, then the direction of hand movement is from bottom side to top side;
if the movement of Cyav dominates and movement direction is occurred in the Y axis, and the Y axis element of the next sequence point Ci+1 from Ci is greater than the Y axis element of Ck, then the direction of hand movement is from top side to bottom side. Finally, if the movement direction is changed during the decision process period, then the hand movement is U-turned from top then bottom on X axis.
If the movement of Cyav dominates and movement direction is occurred in the Y axis, and the Y axis element of midpoint Ci is smaller than Y axis element of C1, then the direction of hand movement is from top side to bottom side;
if the movement of Cyav dominates and movement direction is occurred in the Y axis, and the Y axis element of the next sequence point Ci+1 from Ci is smaller than Y axis element of Ck, then the direction of hand movement is from bottom side to top side; and
Finally, if the movement direction is changed during the decision process period, then the hand movement is U-turned from bottom then top on X axis.

Specifically, for FIG. 5C, the movement of C is diagonal and meets the following condition: If the change of X coordinates from C1 to midpoint Ci is positive and change of Y coordinates from C1 to midpoint Ci is also positive and the change of X coordinates from Ci+1 to Ck is negative and the change of Y coordinates from Ci+1 to Ck is negative, then the U-turn hand gesture on diagonal direction is from lower left corner to center, then return to lower left corner.

If the movement of C is diagonal direction and meets the following condition: If the change of X coordinates from C1 to midpoint Ci is negative and change of Y coordinates from C1 to midpoint Ci is also negative and the change of x coordinates from Ci+1 to Ck is positive and the change of Y coordinates from Ci+1 to Ck is positive, then the U-turn hand gesture on diagonal direction is from upper right corner to center, then return to upper right corner.

If the movement of C is diagonal direction and meets the following condition: If the change of X coordinates from C1 to midpoint Ci is negative and change of Y coordinates from C1 to midpoint Ci is positive and the change of x coordinates from Ci+1 to Ck is positive and the change of Y coordinates from Ci+1 to Ck is negative, then the U-turn hand gesture on diagonal direction is from lower right corner to center, then return to lower right corner.

If the movement of C is diagonal direction and meets the following condition, If the change of X coordinates from C1 to midpoint Ci is positive and change of Y coordinates from C1 to midpoint Ci is negative and the change of x coordinates from Ci+1 to Ck is negative and the change of Y coordinates from Ci+1 to Ck is positive, then the U-turn hand gesture on diagonal direction is from upper left corner to center, then return to upper left corner.

Furthermore, another dozen of new input commands could be created by specifying a different time window of image blocking. In other words, each hand gesture shown in FIG. 5A, FIG. 5B and FIG. 5C could make two different kinds of input command sets corresponding to a shorter time duration of optical blocking (e.g. covers the marker for 500 milliseconds) action or a longer time duration of optical blocking (e.g. the covers the marker for 2 seconds) action. Therefore, twelve different hand gestures shown in FIG. 5A, FIG. 5B and FIG. 5C could increase to twenty four different input commands corresponding to various optically different blocking behaviors.

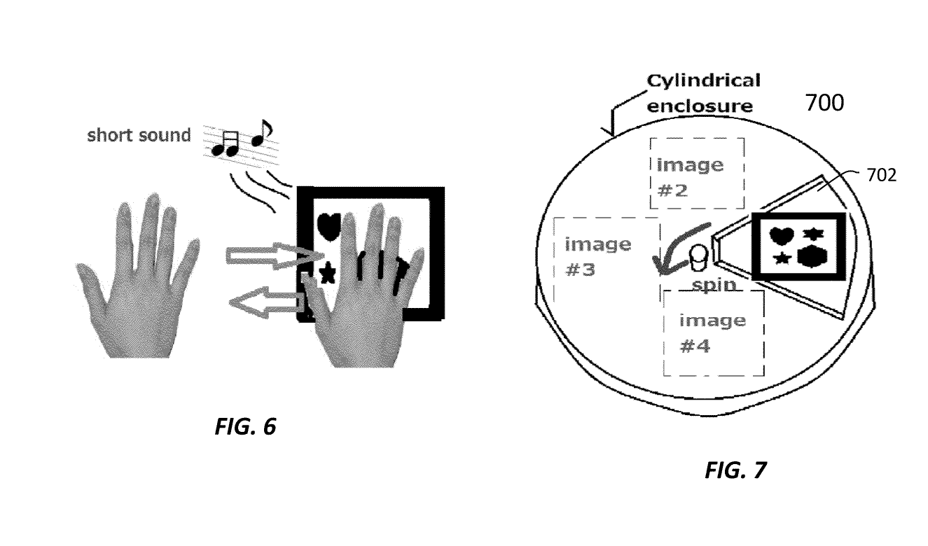

According to one embodiment, FIG. 6 shows an audio feedback function to provide the user with the confirmation of an expected command by hand gesture. For example, a simple swipe gesture of hand from left to right in FIG. 5A could provide the sound of piano when the moving speed of hand gesture is slow and its optical blocking is about 2 seconds. When the same swipe gesture is fast and its optical blocking is about 500 msec, then the audio feedback can be set to a whistle sound.

A markerless image could be any printed paper, large poster, game card (e.g., a thick plate with cartoon printing) and so on. FIG. 7 shows a cylindrical enclosure 700 with an opening 702. The cylindrical enclosure 700 contains multiple target images. The opening 702 is made just large enough to expose one of the target images. The user can use several target images for his/her desired AR information by spinning the opening 702 to swap from one target image to another so as to cause the AR module to display a corresponding object.

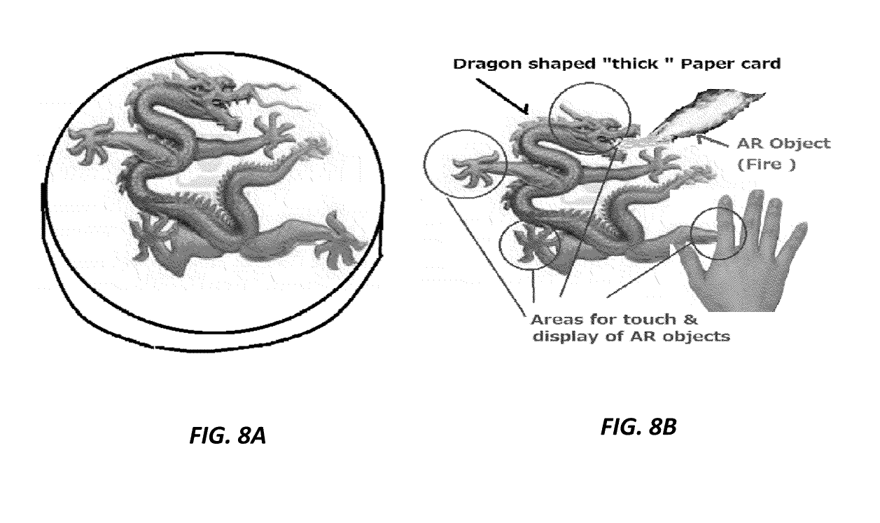

FIG. 8A and FIG. 8B shows a cartoon plate, when detected, to display an AR. FIG. 8A shows the original cartoon plate 800 on which there is a graphic design (e.g., a dragon). Examples of the feature points are presented in circles shown in FIG. 8B. When a user blocks some of the feature points by placing a hand or some fingers, only some of the feature points are detected and located in a natural scene image including the graphic design, an AR object is displayed (overlaid in the image). In other words, the AR module detects some feature points are missing from the expected region and is caused to determine what command is meant from the user, a simple command to display an AR object or one of the commands by determining the motion of the hand or fingers first.

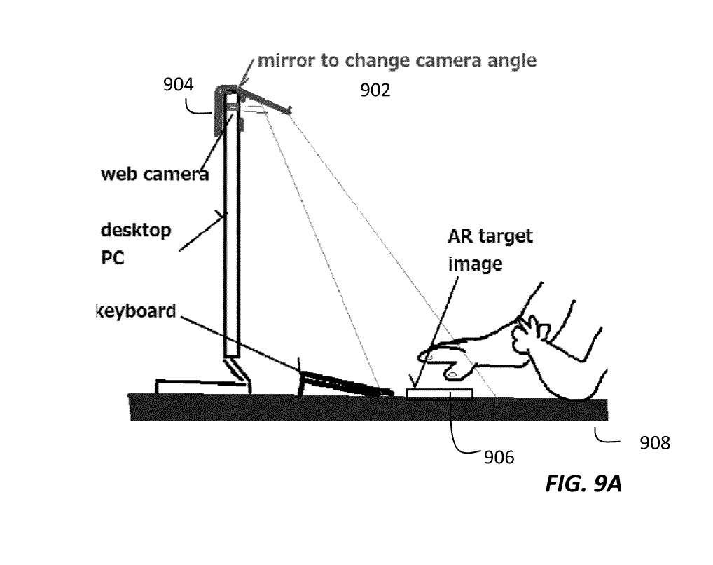

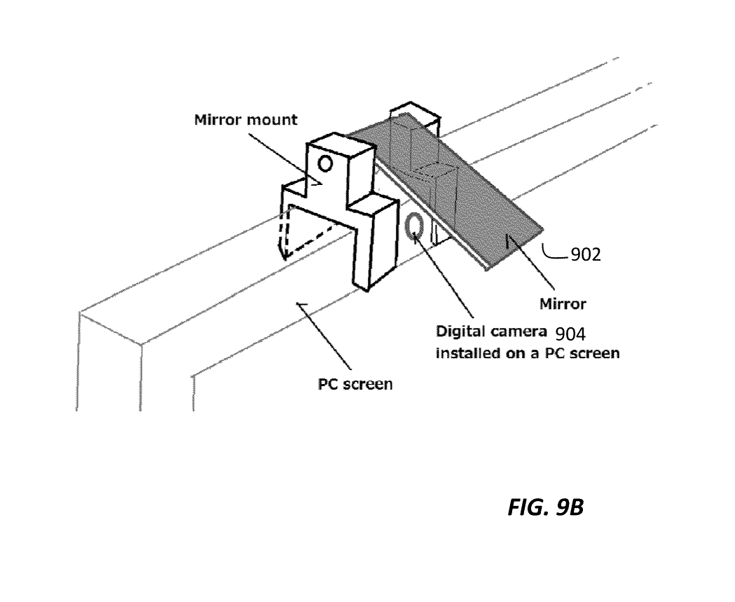

FIG. 9A and FIG. 9B show an example for users using desktop computers. In particular, FIG. 9A shows that a mirror 902 is mounted near a webcam 904. In general, the webcam 904 is fixed on a display screen to allow a user to video him/herself for various applications. With the mirror 902, the webcam 904 is able to view an AR target 906 laid open on a desk 908 to generate an AR target image. As further shown in FIG. 9B, the mirror 902 is adjustable so that a user can adjust to mirror 902 to ensure that the AR target 906 is in the field of view of the webcam 904. The angle adjustable mirror installed in front of a web camera could provide a convenient environment to display AR objects while the user places an AR target on his/her desk.

The invention is preferably implemented in software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The processes, sequences or steps and features discussed above are related to each other and each is believed independently novel in the art. The disclosed processes and sequences may be performed alone or in any combination to provide a novel and unobvious system or a portion of a system. It should be understood that the processes and sequences in combination yield an equally independently novel combination as well, even if combined in their broadest sense; i.e. with less than the specific manner in which each of the processes or sequences has been reduced to practice.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

We claim:

1. A system for providing augmented reality (AR) content, the system comprising:
a computing device loaded with a module related to augmented reality;
a video camera, aiming at a physical target, coupled to the computing device, wherein the module is executed in the computing device to cause the computing device to display a first object when the physical target in a target image is fully detected and to cause the computing device to conceal the first object being displayed or display a second object when the physical target in the target image is partially detected.

2. The system as recited in claim 1, wherein the video camera generates a sequence of target images of the physical target while a hand is moving with respect to the physical target, the module causing the computing device to detect how the physical target is being blocked by determining an area of the physical target in the target images.

3. The system as recited in claim 2, wherein the computing device is caused by the module to detect a blocking area in each of the target images to determine how the hand is moving with respect to the physical target.

4. The system as recited in claim 3, wherein respective sizes of the blocking area in the target images indicate a motion of the hand moving with respect to the physical target.

5. The system as recited in claim 4, wherein the respective sizes of the blocking area in the target images increased and then decreased along one direction indicate that the hand is moving across the physical target.

6. The system as recited in claim 4, wherein the respective sizes of the blocking area in the target images increased and then decreased along two directions indicate that the hand is U-turned along the physical target.

7. The system as recited in claim 4, wherein the respective sizes of the blocking area in the target images are calculated by detecting an edge or contour of the blocking area.

8. The system as recited in claim 1, wherein the physical target is a marker.

9. The system as recited in claim 8, wherein the physical target is one of markers stored in an enclosure with an opening, the opening is just large enough to expose one of the markers, each of the marker corresponding to one input command.

10. The system as recited in claim 1, wherein the physical target is a markerless target.

11. The system as recited in claim 10, wherein the physical target is a representation of a natural scene.

12. The system as recited in claim 1, wherein the computing device is caused to determine a time of how long the target has been partially or fully blocked, the time is set to correspond to an input command.

13. The system as recited in claim 1, wherein the video camera and the computing device are integrated and used as a single device.

14. A portable device for providing augmented reality (AR) content, the portable device comprising:
a camera aiming at a physical target;
a display screen;
a memory space for a module;
a processor, coupled to the memory, executing the module to cause the camera to generate a sequence of target images while a user of the portable device moves a hand with respect to the physical target, and
wherein the module configured to cause the processor to determine from the target images whether or how the physical target is being blocked by the hand, the processor is further caused to display an object on the display screen when the physical target is detected in the images, and determine a motion of the hand when the physical target is partially detected in the images, where the motion corresponding to an input command.

15. The portable device as recited in claim 14, wherein the video camera generates a sequence of target images of the physical target while a hand is moving with respect to the physical target, the module causing the portable device to detect how the physical target is being blocked by determining an area of the physical target in the target images.

16. The portable device as recited in claim 15, wherein the portable device is caused by the module to detect a blocking area in each of the target images to determine how the hand is moving with respect to the physical target.

17. The portable device as recited in claim 16, wherein respective sizes of the blocking area in the target images indicate a motion of the hand moving with respect to the physical target.

18. The portable device as recited in claim 14, wherein a time for the physical target being blocked is measured to determine what an input command the time corresponds to.

19. The portable device as recited in claim 14, wherein the physical target is a marker or a markerless target.

20. A method for providing augmented reality (AR) content, the method comprising:
providing a module to be loaded in a computing device for execution, the module requiring a video camera to aim at a physical target, the video camera coupled to a computing device, wherein the computing device is caused to display a first object when the physical target in a target image is fully detected, and to conceal the first object being displayed or display a second object when the physical target in the target image is partially detected.
